(19) United States
(12) Patent Application Publication
(10) Pub. No.: US 2026/0355663 A1
(43) Pub. Date: Nov. 12, 2026

(54) METHOD FOR CREATING A FILTER HOSE UNIT AND FILTER HOSE UNIT

(71) Applicant: PFAFF INDUSTRIESYSTEME UND MASCHINEN GMBH, Kaiserslautern (DE)

(72) Inventor: Karl Herzer, Kaiserslautern (DE)

(73) Assignee: PFAFF INDUSTRIESYSTEME UND MASCHINEN GMBH, Kaiserslautern (DE)

(21) Appl. No.: 19/113,412

(22) PCT Filed: Jul. 21, 2023
(86) PCT No.: PCT/EP2023/025343

§ 371 Date: Mar. 19, 2025

(30) Foreign Application Priority Data
Jul. 21, 2022 (DE) 10 2022 002 664.3

(51) Int. Cl. B01D 46/00; B01D 46/02; F16L 11/02; F16L 33/34

(52) U.S. Cl. CPC B01D 46/0001; B01D 46/0005; B01D 46/023; F16L 11/02; F16L 33/34; B01D 2265/06

(57) ABSTRACT

A method for creating a filter hose unit for a filter system for filtering dust and/or smoke-laden gases, in which, in the region of two parallel longitudinal edges of a flexible textile workpiece, a seam is created for connecting the two regions of the longitudinal edges and the textile workpiece is thereby formed into a flexible tube of a filter hose, and at least approximately circular base part is attached to an end side of the tubular filter hose using a welding method, in order to close the filter hose in the region of its base, and a wire frame is introduced into the filter hose to stabilise the shape of the filter hose.

The invention relates to a method for producing a filter hose unit for a filter system for filtering dust- and/or smoke-laden gases, in which a flexible textile workpiece is joined in the region of two mutually parallel longitudinal edges by producing a seam to form a filter hose, an at least approximately flat base part is attached to one front side of the tubular filter hose produced in this way by means of a welding process, in order to close the filter hose in the region of its base, and in which a wire frame is introduced into the filter hose to stabilize the shape of the filter hose or is surrounded by at least one outer wire ring.

In particular, industrial production, combined heat and power plants for electricity generation or waste disposal can produce gases contaminated with particles, such as flue gases or other dust-laden gases. Examples of this are coal-fired power stations, cement works or even waste incinerators. So-called filter hose units are often used to clean dust, smoke and other solid particles from these gases before they are released into the environment. In this case, a large number of filter hose units are usually arranged in a chamber to clean the gas that is introduced into the chamber. In the chamber, the gas passes an outer side of the filter hoses of the filter hose units and flows through the respective filter hose from the outside to the inside. However, solutions have also been devised in which the gases flow through the filter hoses from the inside to the outside. Both variants are also possible in connection with the present invention. If the gas flows from the outside to the inside, the filter hose units usually have a wire frame inside them to stabilize their shape. Due to the filter effect of the filter hose and the flow from the outside to the inside, the particles contained in the gas collect on the outside of the filter hose as a filter cake. To remove the latter from the respective filter hose, it may be possible to vibrate the filter hose, or the filter hose unit as a whole, by machine, causing the filter cake to fall off the filter hose. This reduces the flow resistance of the filter hose again and at least substantially restores the original filter effect of the filter hose. This shaking movement is usually repeated regularly in certain cycles.

To produce a filter hose unit of this kind, a textile fabric, for example made of synthetic needle felt, is usually joined together at two parallel edge regions to form a cylindrical tube. This longitudinal seam can be produced by means of an automatic sewing machine in a single sewing process. In other known methods, such longitudinal seams are also produced by welding. After the seam has been produced, the filter hose is closed around its circumference but open at both ends. A head and a base part are then attached to the two front sides. The head part is used to arrange the filter hose unit hanging in the filter system during subsequent use. For attaching the base part, both methods with a sewing process and methods with a welding process are known. In the case of high-quality filter hose units, stitched seams can be welded with a band and thus sealed in order to reduce the permeability of particles in the region of the stitching seam, which can otherwise occur due to the needle puncturing the material of the filter hose.

The attachment of the base part is associated with particular difficulties. The filter hoses are made of flexible materials, the bottom-side opening of which does not remain in a circular nominal shape by itself. However, the front end must be brought into this circular shape in order to attach the base part to the filter hose, or at least this makes attaching the base part considerably easier. It is therefore common practice to insert the wire mesh into the filter hose before attaching the base part, which gives the filter hose its cylindrical shape. This means that the circular shape required for attaching the base part can be created at least approximately on the bottom front side of the filter hose. This is particularly time-consuming for filter hoses that are often several meters long, and handling the filter hose, which is then very unwieldy, when attaching the base part is also particularly difficult.

Sealing with additional tapes can also be disadvantageous, although this may be necessary if the base part is attached to the filter hose by sewing. Filter hoses with PTFE coatings are increasingly being used. If tapes are to be applied to these bags to seal the seams, very high temperatures are required, which, however, produce harmful fluorine-containing exhaust gases.

Considerable additional expense can arise if filter hoses with different nominal diameters are to be manufactured frequently and in particular in alternation. In this case, the sewing and welding machines and their tools have to be converted at great expense.

The invention is therefore based on the problem of specifying a method that can be used to produce a filter hose unit of the type mentioned at the beginning and with which a base part can be non-detachably attached to a filter hose with the least possible technical effort, but still in a high-quality manner.

In a method for producing a filter hose unit of the type mentioned at the beginning, this problem is solved in accordance with the invention by attaching the base part to the filter hose and connecting it to it by means of a friction welding process, in particular a rotational friction welding process.

The problem is also solved by a filter hose unit according to claims 8 to 12 and by a production device according to claim 13.

Although solutions have already become known from the state of the art through WO 97/18883, in which the base part of a filter hose unit is attached by means of a welding process, the solution does not use a friction welding process. However, as has been shown in the context of the invention, friction welding processes are particularly suitable for fastening the base part and provide special advantages. Thus, a friction welding process makes it possible in a particularly favorable way to melt the components to be joined together only in the regions where the components are to be joined together. In contrast to other welding processes, a plasticizing/melting can also be carried out in a targeted manner only in surface regions of the components and not in the entire needle felt, of which the filter hose and the floor part often consist. These surface regions can advantageously be internal surface regions in particular, which are in contact with each other during the friction welding process and the relative movements of the components to be joined, and are not accessible from the outside. In this process, the components are preferably not plasticized/melted over their entire component thickness and subsequently cooled down again, but only superficially in the respective contact region. This also helps to prevent the components from becoming brittle in the region of the welded seam, which could otherwise easily lead to seam breaks when the filter hose unit is in use, for example due to the regular shaking processes used to shake the filter cake off the outside of the filter hose.

In a particularly advantageous manner, the friction welding process, by means of which the base part is welded to the bottom-side front side of the filter hose, can be designed as a rotational welding process or at least include a rotational process step. In this process, the components to be connected to one another perform a relative rotational movement, preferably while simultaneously exerting an axial contact pressure of the two components against one another. Such a process can be realized with particularly little effort, since all that is required for this is a relative rotational movement between the base part and the front end of the filter hose. Preferably, the rotational movement can be carried out by the base part, which is at least approximately circular in shape, while the filter hose is arranged, fixed and stationary in a holding device during the rotational welding process. In other embodiments of the invention, however, it is also possible for the relative rotational movement to be performed by the filter hose. It is also possible to divide the relative rotational movement between the components between the base part and the filter hose, so that both components can perform a rotational movement simultaneously or in succession.

In a preferred embodiment of the method according to the invention, the speed and the axial pressure can be selected as a function of the intended materials of the joining partners. Similarly, the duration of the rotation can be selected so that sufficient liquefaction and a sufficient melt thickness are generated. When this state is reached, the rotating joining partner can be braked to a standstill. A holding phase under an axial holding pressure can then preferably follow. The holding pressure can differ from the pressure during the preceding friction phase. Just like the friction pressure, the holding pressure can also vary during the duration of the friction phase or holding phase and not be constant. During the holding phase, the melt cools and solidifies, whereby the two joining partners are permanently connected to one another.

A preferred embodiment of the invention, which is also tolerant of any inaccurate alignment of the base part with respect to the front end of the filter hose and also of tolerances of the two workpieces, can provide that the base part is attached to the filter hose in the region of the front end of the filter hose on the inner side of the filter hose by means of the friction welding process.

The manufacturing process for a filter hose unit according to the invention can, in a preferred embodiment, provide for one end of the filter hose to be inserted into a first end of an annular workpiece holding device for the filter hose, the inserted end of the filter hose to be passed through the annular workpiece holding device, the front side of the filter hose is guided out of the other end of the ring-shaped workpiece holding device and, in the region of its front side end that has been guided through, is brought to bear with its outer side (circumferential side) on one front side of the ring-shaped workpiece holding device. The base part is then brought into contact with the inner side of the filter hose and the base part is set in a rotary relative movement with respect to the filter hose. As a result of the relative movement and the pressure exerted by the base part on the filter hose or vice versa, the contact regions between the base part and the inner side of the filter hose are superficially plasticized or melted and flow into each other. The rotational movement can then be stopped, which in turn leads to cooling of the molten or plasticized regions and to the firm local connection of the base part to the filter hose over a large area. The connection point between the base part and the filter hose can thus have an approximately circular shape.

Also deviating from the previously usual procedure for attaching the base part to the front end of the filter hose, it can advantageously be provided that the base part is first attached to the front end of the filter hose and only after that the frame, in particular a wire frame, which stabilizes the shape of the filter hose, at the opposite end of the filter hose is introduced into the latter and pushed into its final position in the filter hose. The subsequent introduction of the frame into the filter hose, which is often several meters long, makes the process of attaching the base part to the filter hose much easier.

Further preferred embodiments of the invention are set out in the claims, the description and the drawings.

The invention is explained in more detail on the basis of the purely schematic examples shown in the figures, which show:

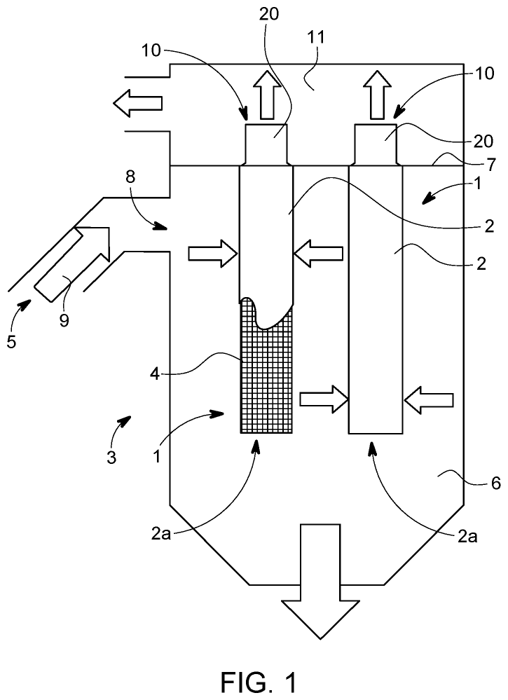

FIG. 1 a highly schematic representation of a filter system with several filter hose units inserted in it, some of which are shown cut;

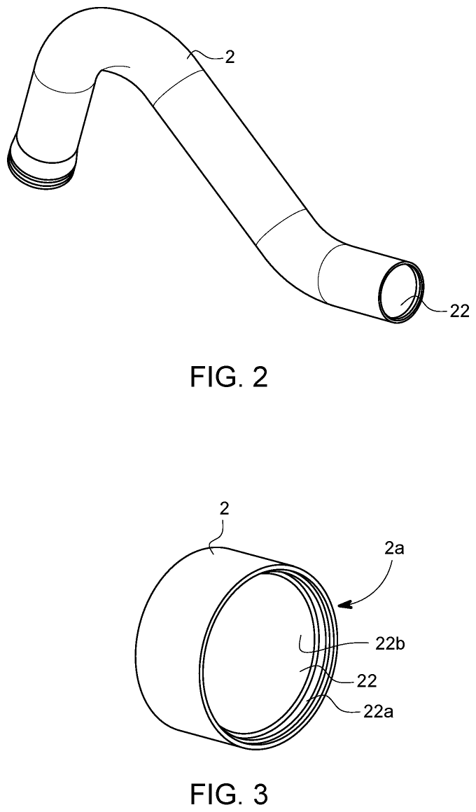

FIG. 2 a complete filter hose from one of the filter hose units from FIG. 1 in a preferred embodiment;

FIG. 3 a detailed view A of a lower end of the filter hose from FIG. 2;

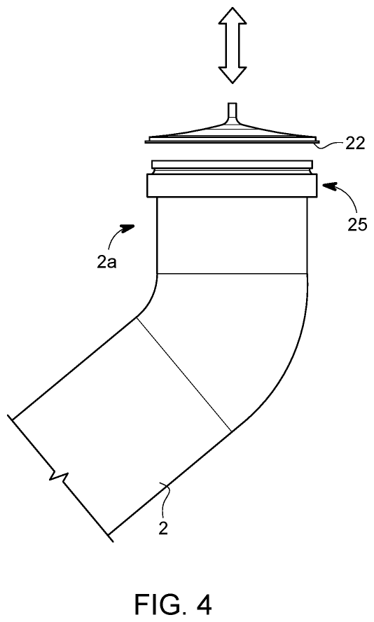

FIG. 4 a front side of a filter hose and a base part held by a disc holder of a rotary welding machine;

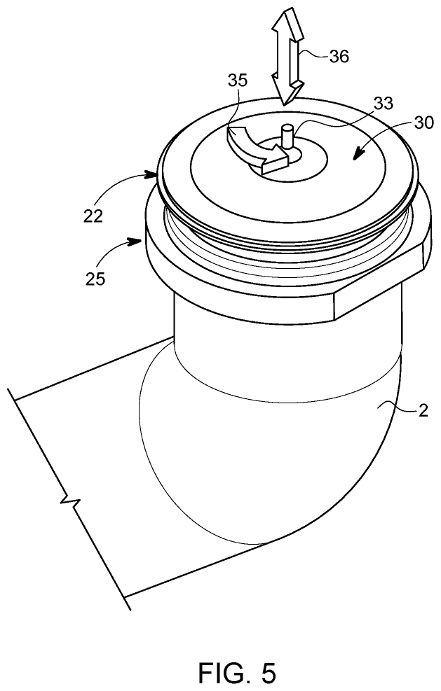

FIG. 5 the filter hose, disc holder and base part from FIG. 3 in a perspective view from above;

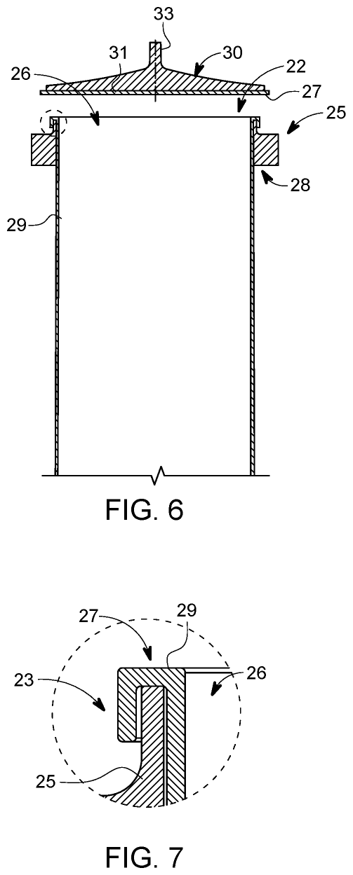

FIG. 6 the filter hose, disc holder and base part from FIG. 3 in a longitudinal section;

FIG. 7 a detailed view C from FIG. 6.

FIGS. 1 and 2 show a preferred embodiment of a filter hose unit 1 according to the invention. The main component of this device is a filter hose 2 which, in its position of use, has an at least substantially cylindrical shape or tubular shape. A wire or supporting frame 4 can be arranged in the filter hose 2, which gives the filter hose 2 its desired shape and dimensional stability in its position of use. Such supporting frames 4 are per se known in connection with filter hose units 1. The filter hose 2 can be made of a flexible material or at least consist predominantly of such a material. Regardless of the further features and characteristics described in connection with this exemplary embodiment of the invention, examples of suitable materials for the filter hose 2 and the base part 22 are, in particular, thermoplastics, for example, polyester, polyamides, polypropylene, polyethylene, acrylic, polyphenylene sulfide and further materials from the group of thermoplastics, as well as mixtures thereof and mixtures with fibers of other materials. Thermoplastic elastomers may also be suitable in principle. This list is only exemplary and not complete. In this case, textile webs made of these materials are used which have sufficient gas permeability and at the same time a filter effect for solid particles, such as those found, for example, in the flue gas from waste incinerators, cement power plants or in power plants in which fossil fuels are burned to generate electricity. This is not an exhaustive list of possible applications for filter hose units 1 according to the invention; in principle, they can be used for any form of cleaning or separating solid particles from gases.

The filter hose unit 1 can also optionally be provided with one or more external reinforcements, for example at least one, for example centrally arranged, cuff-like reinforcement, as well as cuff-like reinforcements, which are arranged at the head-side end and at the bottom-side end of the filter hose 2. These reinforcements can be attached to the filter hose with seams, for example also with one or more double seams. The head-side reinforcement can additionally be provided with a fastening aid for the releasable and hanging arrangement of the filter hose unit 1 in a filter system 3. Such a fastening aid can, for example, be an elastic snap ring (not shown) incorporated in the upper (head-side) reinforcement, which, as part of a snap connection, can be quickly and preferably detachably fastened without tools to a receiver of the filter system 3. Such a filter system is shown in FIG. 1 in a purely schematic form. It involves a chamber 6 into which an exhaust gas channel 5 leads. In chamber 6, several such filter hose units 1 are arranged hanging. For this purpose, a ceiling element 7 of chamber 6 can have circular recesses or openings, into each of which one of the filter hose units 1 can be inserted. Usually, a multiplicity of filter hose units 1 are arranged simultaneously in such a filter system 3. A diameter of the recesses in the ceiling element 7 can be matched to the diameter of the respective snap ring in such a way that the snap ring can be pushed through the recess with force, relax behind the recess and the filter hose unit 1 then rests on the ceiling element 7 with an upper ring element (not shown) at the edge region of the recess. The filter system 3 can have an inlet 8 through which gas to be cleaned flows into the chamber 6. In the illustration of FIG. 1, the unpurified gas/flue gas flowing in through the inlet 8 is symbolized by the arrow 9. An excess pressure in chamber 6 causes the gas to be cleaned, for example flue gas, to pass through filter hose 2 of filter hose unit 1 into the interior of the latter and particles, for example particles in the flue gas, to be collected by filter hose 2 in the process. The flue gas, which has been cleaned after passing through the filter hose 1, then passes through the open upper end 10 of the respective filter hose unit 1 to the outlet 11 of the filter system 3 and then through a further outlet to the outside. The filter hose units 1 can be shaken at certain time intervals, causing the filtered particles to be shaken off the filter hoses 2.

To produce such a preferred embodiment of a filter hose unit 1 according to the invention, an at least substantially rectangular, flexible, textile blank or a fabric or textile web of a filter material, such as needle felt, pre-cut in this form, can be provided for the cylindrical shape to be achieved. The blank should have a length corresponding at least approximately to the length of the filter hose 2 to be produced. Typically, filter hose units 1 have a length of up to several meters. The width of the blank can be matched to the diameter of the filter hose 2 to be achieved, since the width of the blank corresponds at least approximately to the circumference of the filter hose 2. The flexible blank is shaped in such a way that the edge regions of the long longitudinal edges overlap, so that in this region there is a double layer of material. The blank has been shaped in such a way that in the overlapping region an outer side of the blank comes to lie against an inner side of the blank. The blank can then be provided in this overlapping region with one or more longitudinal seams, which run parallel to the edge regions over their entire length, by means of a seam-producing device, in a manner known per se. These can be sewn or welded seams. The latter are possible due to the materials commonly used for such filter materials, which have at least a high proportion of thermoplastic fibers. If the edge regions are provided with one or more parallel stitched seams, a thermoplastic tape can be welded onto the at least one seam after the one or more seams have been created, in order to seal it and to prevent particles from the gas to be cleaned from passing through the stitches made in the material during stitching.

Now the head part 20 can be attached to the filter hose 2 in a manner known per se at what will later be the upper end of the filter hose 2, namely by sewing a previously separately prefabricated head cuff to the head end. The clamping ring can be incorporated in this head part. Alternatively, the head part 20 can also be added only at the end of the production of the filter hose 2, that is to say after the base part 22 has already been added to the filter hose 2.

The base part 22 (e.g. FIG. 3) can be attached to the lower end 2a of the filter hose 2—with regard to the position of use of the filter hose unit 1—before or after this. The base part 22 is in this case not yet attached and unloaded a circular disc (FIGS. 4-6) and has preferably the same material or the same textile material as the filter hose 2, which is at least substantially gas permeable. The material of the base part 22 is thus also preferably flexible, i.e. not inherently dimensionally stable. The base part 22 can also be a needle felt, for example. In principle, however, it is also conceivable that the material of the filter hose 2 is different from the material of the base part 22. Since the filter hose 2 is to be friction welded to the base part 22 in the region of its lower end, it should be advantageous to provide that the two materials melt when a rotary friction welding process is used, mixing with each other and forming a material-locking connection with each other when cooling.

As shown in FIGS. 4-7, in order to attach the base part 22 to the lower front side 2a of the filter hose 2—with respect to the later position of use—this end can be introduced into a holding device 25, which is exemplarily shown in FIGS. 5-7. The holding device 25 can essentially have a ring shape with a cylindrical through-recess 26. In the region of one front side 27 of the holding device 25, this can have a smaller external diameter than at its other front side 28.

In order to be arranged in the holding device 25, the lower end 2a of the filter hose 2, which is located at the front side (with regard to the position of use), is guided from the front side 28 of the holding device 25 into the through-recess 26 and through the latter. In order to be able to carry this out with little effort, it is helpful if, preferably, the wire or supporting frame 4 has not yet been inserted into the filter hose 2 and the filter hose 2 can be handled with little effort. The front end 2a of the filter hose 2 is passed completely through the through-recess 26 and then turned up or everted at the other front side 27 of the holding device 25. The beading or turning-up 23 takes place, for example, over a length which corresponds approximately to the length over which the holding device 25 has a smaller outer diameter at this front side 27 than in the remaining outer circumferential region of the holding device 25. In this way, the inner side 29 of the filter hose 2 is exposed in the region of the front side 27 of the holding device 25 and is directly accessible.

The base part 22 can be received by a disc holder 30. For this purpose, the substantially circular contact side 31 of the disc holder 20 can preferably be provided with a hook-and-loop fastener which hooks into the textile material of the filter hose 2 and holds it fast. Another possibility for holding the base part 22 on the disc holder 30 for the friction welding process may be that the base part 22 is sucked on by means of a vacuum or held in a rotation-proof manner by means of barbs. The size of the contact surface of the disc holder 30 can essentially correspond to the size of the surface of the base part 22. On its side opposite the receiving surface, the disc holder 30 has a bolt 33 with which it can be clamped in a lathe chuck of a rotary drive. The chuck can be part of a rotary welding machine, as is known per se and in another context. In this, the disc holder 30 clamped in the chuck is set in rotation (arrow 35) by a motorized drive and the disc holder 30 is pressed against the inner side 29 of the filter hose 2 in the direction of the axis of rotation by a predeterminable force (arrow 36) exerted by the rotary welding machine, which rests with its outer side on the front side 27 of the holding device 25. Alternatively, the holding device 25 could also be force-loaded in the direction of the axis of rotation and the disc holder 30, in order to press the filter hose 2 against the base part 22. The speeds and forces required for this speeds and the forces to be applied can be determined with a few tests and, in addition, can be based at least to a large extent on empirical values. Typical suitable rotational speeds in the contact region can, for example, be selected from a range of 100 m/min to 500 m/min. With typical diameters of the filter hoses of 60 mm-400 mm, which can also be provided in preferred embodiments of filter hoses according to the invention, these preferred rotation speeds correspond to speeds from a range of 80 rpm to 2,200 rpm. Preferred speeds may also be selected from a range of 60 rpm to 3000 rpm.

As can be seen in particular in FIGS. 4-7, the preferably rotationally symmetrical base part 22 is pressed centrally against the region of the inner side 29 of the filter hose 2. The base part 22 can also have a slightly larger diameter than the diameter of the filter hose 2. The base part 22 thus comes into contact with an annular section of the region of the inner surface 29 of the filter hose 2 that is at a distance from the edge of the base part 22. In this circular ring, along which the two components are now in contact with each other, the materials of these two components heat up and melt locally. The friction should thus plasticize the materials of the two components in their contact region, i.e. they should be heated as close as possible to their melting point at this point. This makes the materials flowable and, as a result of the applied pressure and rotational movement, the materials can also flow into each other. The relative rotational movement between the base part 22 and the filter hose 2 can now be stopped, causing the plasticized materials to cool again and solidify into each other. In this way, a friction welding connection is produced by means of the rotational friction welding process between the base part 22 and the inner side 29 of the filter hose 2 in the region of its lower front side (relative to the subsequent position of use). By selecting suitable parameters of the rotational friction welding process that are matched to the respective contact partners, in particular the rotational speed in the contact region, as well as the contact pressure exerted in the axial direction between the two contact partners, should preferably be achieved in such a way that the materials in the contact region do not melt over the entire thickness but only to the extent necessary to create a connection in the contact region of the two components. This largely avoids brittleness of the components, which can occur when there is extensive and continuous plasticization of thermoplastic components or materials. The components thus remain more ductile and are less likely to break.

After completing the attachment of the base part 22 in the region of the lower front side 2a and thus the connection between the base part and the filter hose, the filter hose 2 that has been produced so far can be removed from the holding device 25. As far as the flexibility of the filter hose 2 allows, the filter hose can now be removed from the holding device in the opposite direction to that in which it was inserted. This also reverses the folding or turning inside out in the region of the lower end 2a of the filter hose and restores the cylindrical shape in this region as well. The attached base part 22 and also the connection between the base part 22 and the filter hose 2 are thus located inside the filter hose 2, as shown in FIGS. 2 and 3. The base part 22 now has a kind of collar or fold in its edge region as a result. The edge region 22a of the base part 22 is at least approximately perpendicular to the free, non-connected circular surface 22b of the outside of the base part 22. Alternatively, the filter hose 2 can also be pulled through the holding device 25 in the insertion direction along its entire length and thereby led out of the holding device 25. Another alternative is to make the holding device 25 in two parts, so that two ring halves are opened, the filter hose 2 is laterally removed and then the holding device 25 is either closed again or before closing a new filter hose 2 is introduced into the holding device, for a new attachment of a base part 25.

After that, the wire or supporting frame 4 can be inserted into the filter hose 2. This is done from the open top side of the filter hose 2, which is pushed completely through the filter hose 2 up to the base part 22 with its one end. After that, the filter hose unit 1 is completed and can be used in a filter system.

In order to be able to produce filter hose units 1 with different diameters with as little effort as possible, several identical holding devices 25 can be provided, but with passage recesses 26 of different diameters. If filter hose units 1 with large differences in diameter are to be manufactured, disc holders 30 for the base parts 22 can also be provided with contact surfaces of different sizes. By varying the size of the holding devices 25 and optionally and if necessary, also by varying the size of the disc holder 30, it is possible to manufacture filter hoses 2 with different dimensions in the same production plant.

Reference designation list

| | |
|---|---|
| 1 | filter hose unit |
| 2 | filter hose |
| 2a | lower end |
| 3 | filter system |
| 4 | wire or support frame |
| 5 | exhaust gas channel |
| 6 | chamber |
| 7 | ceiling element |
| 8 | inlet |
| 9 | arrow |
| 10 | open top |
| 11 | outlet |
| 20 | head part |
| 22 | base part |
| 22a | edge region |
| 22b | surface |
| 23 | beading |
| 25 | holding device |
| 26 | cylindrical passage recess |
| 27 | front side |
| 28 | front side |
| 29 | inner side |
| 30 | disc holder |
| 31 | contact side of 30 |
| 33 | bolt |
| 35 | arrow (rotation) |
| 36 | arrow (force) |

1-13. (canceled)

14. A method for producing a filter hose unit for a filter system for filtering dust- and/or smoke-laden gases, in which a seam for connecting the two regions of the longitudinal edges is produced in the region of two mutually parallel longitudinal edges of a flexible textile workpiece, and the textile workpiece is thereby formed into a flexible hose of a filter hose, and at least approximately circular base part is attached to a front side of the tubular filter hose produced in this way by means of a welding process in order to close the filter hose in the region of its base, and in which a wire or supporting frame is introduced into the filter hose in order to stabilize the shape of the filter hose, wherein the base part is attached to the filter hose by means of a friction welding process and connected to it.

15. The method according to claim 14, wherein the wire or supporting frame is only introduced into the filter hose and brought into its end position in the filter hose after the base part has been attached to the filter hose by means of the rotational friction welding process.

16. The method according to claim 14, wherein the friction welding process is configured as a rotational friction welding process.

17. The method according to claim 14, wherein the base part is attached to the inner side of the filter hose in the region of the front side of the filter hose by means of the friction welding process.

18. The method according to claim 14, wherein one end of the filter hose is introduced into a first end of an annular holding device, the introduced end of the filter hose is passed through the annular holding device, the front side of the filter hose is passed out of the other end of the annular holding device and, in the region of its front side that has been passed through, is brought to bear with its outer side on the front side of the annular holding device, then the base part is brought to bear against the inner side of the filter hose and the base part is set in a rotary relative movement with respect to the filter hose.

19. The method according to claim 14, wherein the base part has an overall planar shape during the formation of the connection with the filter hose, and in the region of one of its planar surfaces is connected to an inner side of the filter hose, the front side of the filter hose, to which the base part is connected to the filter hose, is first turned outwards in a flange-like manner, and after the connection has been created by means of the friction welding process, the turned-out front side of the filter hose is turned back again in the region of the connection between the filter hose and the base part.

20. The method according to claim 14, wherein the wire or supporting frame is introduced into the filter hose after the base part has been attached to the filter hose and pushed to an end position in the filter hose in the direction of the base part already welded in.

21. A filter hose unit for use in a filter system which is intended for cleaning gases contaminated with dust, smoke or other particles, the filter hose unit having a filter hose which consists at least predominantly of a flexible gas-permeable textile material web, in particular of needle felt, which is shaped into a cylindrical form and, for this purpose, in the region of two longitudinal edges of the at least substantially rectangular material web, these two longitudinal edges are connected to one another, wherein the filter hose is provided at one of its end sides with a head part which is provided with a means for arranging in the filter system and, at its other end, with a base part, with which the filter hose is closed at this end, the filter hose being further provided with a shape-stabilizing frame, wherein a connection of the base part on the filter hose is formed, which is designed as a friction welded connection, in particular as a rotational friction welded connection.

22. The filter hose unit according to claim 21, wherein in the region of the base part, an inner side of the filter hose is turned outwards in the manner of a flange and the at least substantially disc-shaped base part is attached to the inner side of the outwardly turned region of the filter hose by means of the friction welding connection.

23. The filter hose unit according to claim 21, wherein in the position of use of the filter hose unit the base part is everted in the region of its edge, the filter hose also has the cylindrical shape of the filter hose in the region of its front side, wherein the edge region of the base part protrudes from the free non-connected circular surface of the outer side of the base part.

24. The filter hose unit according to claim 21, wherein the friction welding connection only in the contact region between the base part and the filter hose after heating and plasticizing due to a friction welding process exhibits cooled plastic and an outer side of the base part and of the filter hose is free of plasticized plastic arising during the production of the friction welding connection between the base part and the filter hose.

25. The filter hose unit according to claim 21, wherein the base part in the attached state and in the position of use on the filter hose has a substantially planar disc shape with an edge region bent around the friction welding connection region of the base part on the filter hose.

26. A filter hose manufacturing plant for producing filter hoses from flexible textile materials, which is provided with a seam-producing device which is used at least to produce a connecting seam in the region of two longitudinal edges of a substantially rectangular blank, and a welding device for producing a material-locking connection between a base part and an end side of the filter hose, wherein the welding device is formed as a rotation welding device which is provided with a rotation drive, wherein a holder for receiving a base part in a rotationally fixed manner can be set in rotation in a predetermined direction of rotation at a predeterminable speed by means of the rotational drive, a holding device for receiving the filter hose is provided, wherein the holding device is annular or cylindrical in shape and has a through-recess whose diameter corresponds at least approximately to a nominal external diameter of the filter hose to be produced, so that a region of one end of the filter hose can be passed through the through-recess and, with part of an outer side of the filter hose, can be laid on a front side, in particular an annular face, of the holding device, the holder of the base part can be brought to lie flat against the inner side of the filter hose with pressure and preferably at least as far as possible in a standing position, and can be set in rotation.
